(19) United States
(12) Patent Application Publication
(10) Pub. No.: US 2010/0079605 A1
(43) Pub. Date: Apr. 1, 2010

(54) Sensor-Assisted Motion Estimation for Efficient Video Encoding

(75) Inventors: Ye Wang, Singapore (SG); Lin Zhong, Houston, TX (US); Ahmad Rahmati, Houston, TX (US); Guangming Hong, Singapore (SG)

Correspondence Address: CONLEY ROSE, P.C., 5601 GRANITE PARKWAY, SUITE 750, PLANO, TX, 75024, US

(73) Assignee: WILLIAM MARSH RICE UNIVERSITY, Houston, TX (US)

(21) Appl. No.: 12/568,078

(22) Filed: Sep. 28, 2009

Related U.S. Application Data
(60) Provisional application No. 61/101,092, filed on Sep. 29, 2008.

(51) Int. Cl. H04N 5/228; H04N 7/26

(52) U.S. Cl. 348/208.4; 375/240.16; 375/E07.104; 348/E05.031

(57) ABSTRACT

An apparatus comprising a sensor assisted video encoder (SaVE) configured to estimate global motion in a video sequence using sensor data, at least one sensor coupled to the SaVE and configured to generate the sensor data, and a camera equipped device coupled to the SaVE and the sensor and configured to capture the video sequence, wherein the SaVE estimates local motion in the video sequence based on the estimated global motion to reduce encoding time. Also included is a method comprising obtaining a video sequence, obtaining sensor data synchronized with the video sequence, converting the sensor data into global motion predictors, using the global motion predictors to reduce the search range for local motion estimation, and using a search algorithm for local motion estimation based on the reduced search range.

### CROSS-REFERENCE TO RELATED APPLICATIONS

This application claims priority to U.S. Provisional Application Ser. No. 61/101,092, filed Sep. 29, 2008 by Ye Wang et al., and entitled “Sensor-Assisted Motion Estimation for Efficient Video Encoding,” which is incorporated herein by reference in its entirety.

### STATEMENT REGARDING FEDERALLY SPONSORED RESEARCH OR DEVELOPMENT

This invention was made with government support under Grant Nos. CNS/CSR-EHS 0720825 and IIS/HCC 0713249 awarded by the National Science Foundation. The government has certain rights in the invention.

### REFERENCE TO A MICROFICHE APPENDIX

Not applicable.

### BACKGROUND

Video recording capabilities is no longer found only on digital cameras, but has become a standard component of handheld mobile devices, such as “smartphones”. When a camera or an object in the camera view moves, the captured image will also move. Therefore, a part of an image may appear in multiple consecutive video frames at different but possibly close locations or blocks in the frames, which may be redundant and hence eliminated to compress the video sequence. Motion estimation is one key module in modern video encoding that is used to identify matching blocks from consecutive frames that may be eliminated. Generally, motion in a video sequence may comprise global motion caused by camera movement and local motion caused by moving objects in the view. In the era of amateur video making with mobile devices, global motion is increasingly common.

Most existing algorithms for motion estimation treat motion in the video sequence without distinguishing between global motion and local motion. For example, a block matching algorithm (BMA) may be used on a block by block basis for the encoded picture. Since both global motion and local motion may be embedded in every block, existing solutions often have to employ a large search window and match all possible candidate blocks, and therefore can be computation intensive and power consuming. One approach used for motion estimation is a full search approach, which may locate the moved image by searching all possible positions within a certain distance or range (search window). The full search approach may yield significant video compression at the expense of extensive computation.

Other developed techniques for motion estimation may be more efficient than the full search approach in terms of computation time and cost requirements. Such techniques may be classified into three categories. In the first category, the quantity of candidate blocks in the search window may be reduced, such as in the case of three step search (TSS), new three step search (N3SS), four step search (FSS), diamond search (DS), cross-diamond search (CDS), and kite cross-diamond search (KCDS). In the second category, the quantity of pixels involved in the block comparison of each candidate may be reduced, such as in the case of partial distortion search (PDS), alternative sub-sampling search algorithm (ASSA), normalized PDS (NPDS), adjustable PDS (APDS), and dynamic search window adjustment. In the third category, hybrid approaches based on the previous techniques may be used, such as in the case of Motion Vector Field Adaptive Search Technique (MVFAST), Predictive MVFAST (PMVFAST), Unsymmetrical-cross Multi-Hexagon-grid Search (UMHS), and Enhanced Predictive Zonal Search (EPZS). While the algorithms of the three categories may produce slightly less compression rates than the full search approach, they may be substantially less computation intensive and power consuming. For example, UMHS and EPZS may be used in 264/Moving Picture Experts Group-4 (MPEG-4) AVC video encoding standard for video compression and reduce the computational requirement by about 90 percent. Additionally, a plurality of global motion estimation (GME) methods may be used to obtain initial position for local motion estimation, which may be referred to as a predictor. However, such GME methods may also be computation extensive or inaccurate.

### SUMMARY

In one embodiment, the disclosure includes an apparatus comprising a sensor assisted video encoder (SaVE) configured to estimate global motion in a video sequence using sensor data, at least one sensor coupled to the SaVE and configured to generate the sensor data, and a camera equipped device coupled to the SaVE and the sensor and configured to capture the video sequence, wherein the SaVE estimates local motion in the video sequence based on the estimated global motion to reduce encoding time.

In another embodiment, the disclosure includes an apparatus comprising a camera configured to capture a plurality of images of an object, a sensor configured to detect a plurality of vertical movements and horizontal movements corresponding to the images, and at least one processor configured to implement a method comprising obtaining the images and the corresponding vertical movements and horizontal movements, calculating a plurality of motion vectors using the vertical movements and the horizontal movements, using the calculated motions vectors to find a plurality of initial search positions for motion estimation in the images, and encoding the images by compensating for motion estimation.

In yet another embodiment, the disclosure includes a method comprising obtaining a video sequence, obtaining sensor data synchronized with the video sequence, converting the sensor data into global motion predictors, using the global motion predictors to reduce the search range for local motion estimation, and using a search algorithm for local motion estimation based on the reduced search range.

These and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 is a schematic view of an embodiment of a video encoder.

FIG. 2 is a schematic view of another embodiment of a video encoder.

FIG. 3 is a schematic view of an embodiment of an orthogonal coordinate system associated with a camera.

FIG. 4 is a schematic view of another embodiment of an orthogonal coordinate system associated with a camera.

FIG. 5a is a schematic view of an embodiment of an optical model for a first object positioning with respect to a camera.

FIG. 5b is a schematic view of an embodiment of an optical model for a second object positioning with respect to a camera.

FIG. 6 is a schematic view of another embodiment of an optical model for object positioning with respect to the movement of a camera.

FIG. 7 is a schematic view of a dual accelerometer configuration.

FIG. 8a is a schematic view of an embodiment of motion estimation using a conventional predictor.

FIG. 8b is a schematic view of an embodiment of motion estimation using a sensor-assisted predictor.

FIG. 9a is a schematic view of an embodiment of motion estimation without using image movements from sensor data.

FIG. 9b is a schematic view of an embodiment of motion estimation using image movements from sensor data.

FIG. 10 is a flowchart of an embodiment of a sensor-assisted motion estimation method.

FIG. 11a is a view of an embodiment of SaVE prototype components.

FIG. 11b is a view of an embodiment of a SaVE prototype coupled to a camera.

FIG. 11c is a view of an embodiment of a SaVE prototype system.

FIG. 12 is a chart of an embodiment of a plurality of Peak Signal-to-Noise Ratio (PSNR) plots for video with vertical movement.

FIG. 13 is a chart of an embodiment of a plurality of PSNR plots for video with horizontal movement.

FIG. 14a is a view an embodiment of a first decoded picture for a video frame.

FIG. 14b is a view an embodiment of a second decoded picture for the video frame using SaVE.

FIG. 15 is a chart of an embodiment of a PSNR plot for video with extensive local motion.

FIG. 16a is a view of an embodiment of accelerometer assisted video encoder (AAVE) prototype components.

FIG. 16b is a view of an embodiment of an AAVE prototype coupled to a camera.

FIG. 16c is a view of an embodiment of an AAVE prototype system.

FIG. 17 is a view another embodiment of a decoded picture for a video frame.

FIG. 18 is a chart of an embodiment of a plurality of Mean Sum of Absolute Difference (MSAD) plots for video with vertical movement.

FIG. 19 is a chart of an embodiment of a plurality of MSAD plots for video with horizontal movement.

### DETAILED DESCRIPTION

It should be understood at the outset that although an illustrative implementation of one or more embodiments are provided below, the disclosed systems and/or methods may be implemented using any number of techniques, whether currently known or in existence. The disclosure should in no way be limited to the illustrative implementations, drawings, and techniques illustrated below, including the exemplary designs and implementations illustrated and described herein, but may be modified within the scope of the appended claims along with their full scope of equivalents.

Disclosed herein is a system and method for estimating global motion in video sequences using sensor data. The video sequences may be captured by a camera, such as a handheld camera, and the sensor data may be obtained using a sensor, such as an accelerometer, a digital compass, and/or a gyroscope, which may be coupled to the camera. The global motion may be estimated to obtain initial search position for local motion estimation. Since objects in a scene typically move relatively short distances between two consecutively captured frames, e.g. in a time period of about 1/30 seconds, the local motion search range may be relatively small in comparison to that of the global motion, which may substantially reduce computation requirements, e.g. time and power, and thus improve motion estimation efficiency.

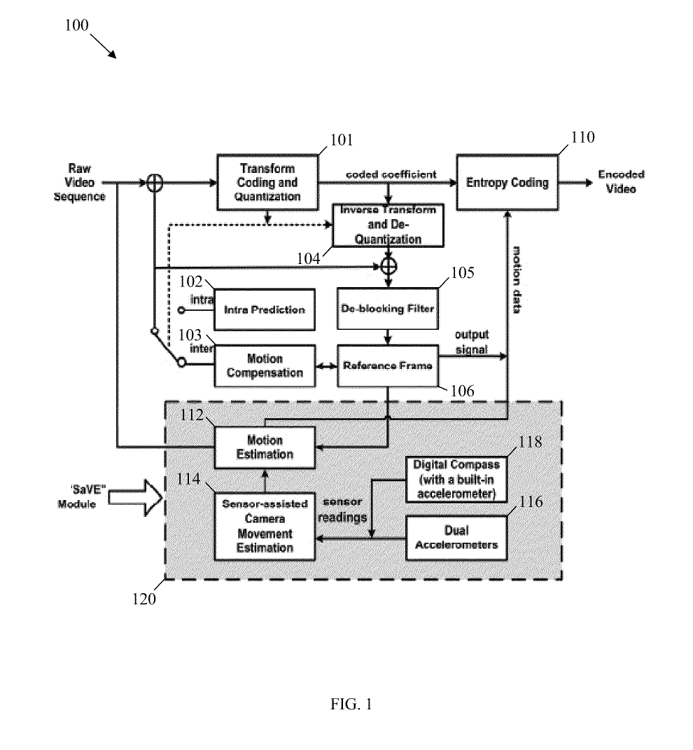

FIG. 1 illustrates one embodiment of a video encoder 100, which may use the H.264/MPEG-4 AVC standard. The video encoder 100 may be positioned in a camera equipped mobile device, such as a handheld camera or a cellphone. The video encoder 100 may comprise a plurality of components, which may be hardware, software, firmware, or combinations thereof. The components may include modules for transform coding and quantization 101, intra prediction 102, motion compensation 103, inverse transform and de-quantization 104, de-blocking filter 105, reference frame 106, and entropy encoding 110. The components may be configured to receive a video sequence, estimate motion in the frames by block matching between multiple reference frames and using multiple block sizes, and provide an encoded video after eliminating redundancy. For instance, the received raw or unprocessed video sequence may be processed by the modules for transform coding and quantization 101, motion compensation 103, and optionally intra prediction 102. The processed video sequence may be sent to the modules for inverse transform and de-quantization 104, de-blocking filter 105, the reference frame 106 to obtain motion data. The motion data and coded coefficients may then be sent to the module for entropy coding 110 to remove redundancy and obtain the encoded video, which may be in a compressed format.

Typically, the components above may be configured to handle both global and local motion estimation, for instance using the full search approach, which may have substantial power and computational cost and therefore pose significant challenge for developing video capturing on mobile devices. Alternatively, a component of the video encoder 100, e.g. at motion compensation 103, may be configured for predictive motion estimation, such as UMHS and EPZS, to reduce the quantity of candidate matching blocks in the frames. Accordingly, instead of considering all motion vectors within a search range, a few promising predictors, which may be expected to be close to the best motion vector, may be checked to improve motion estimation efficiency. Predictive motion estimation may provide predictors based on block correlations, such as median predictors and neighboring reference predictors. A median predictor may be a median motion vector of the top, left, and top-right (or top-left) neighbor blocks of the current block considered. The median motion vector may be frequently used as the initial search predictor and for motion vector prediction encoding. For instance, the predictors in UMHS and EPZS may be obtained by estimating the motion vector based on temporal or spatial correlations. An efficient yet simple checking pattern and reliable early-termination criterion may be used in a motion estimation algorithm to find a preferred or optimal motion vector around the predictors relatively quickly, e.g. in comparison to the full search approach.

In an embodiment, the video encoder 100 may comprise an additional set of components to handle global motion estimation and local motion estimation separately. Specifically, the video encoder 100 may comprise a component for sensor-assisted video encoding (SaVE) 120, which may be configured to estimate camera movement and hence global motion. The estimated global motion may then be used for initial search position to estimate local motion data, e.g. at the remaining components above. As such, the motion estimation results may be provided to entropy coding 110 using less power and time for computation.

The SaVE 120 may comprise a plurality of hardware and software components including modules for motion estimation 112 and sensor-assisted camera movement estimation 114, dual accelerometers 116 and/or a digital compass with built-in accelerometer 118. The dual accelerometer 116 and the digital compass with built-in accelerometer 119 may be motion sensors coupled to the camera and may be configured to obtain sensor data. For example, the dual accelerometer 116 and the digital compass with built-in accelerometer 119 may detect camera rotation movements during video capture by a handheld device. The sensor data may then be sent to the module for sensor-assisted camera movement estimation 114, which may convert the sensor data to global motion data, as described in below. The global motion data may then be used reduce the search range before processing local motion data by the module for motion estimation 112, which is described in more detail below. The resulting motion estimation data may then be sent to the module for entropy coding 110. The power that may be saved by estimating local motion data without global motion data may be greater than the power that may be needed to acquire global motion data using relatively low power sensors. Therefore, adding the SaVE 120 to the video encoder 100 may reduce total power and computational cost for video encoding.

The dual accelerometer 116 and digital compass with built-in accelerometer 119 may be relatively low power and low cost sensors that may be configured to estimate camera rotations. For instance, the accelerometers may be manufactured using micro-electromechanical system (MEMS) technology and may consume less than about ten mW power. The accelerometers may employ suspended proof mass to measure acceleration, including gravity, such as three-axis accelerometers that measure the acceleration along all three orthogonal coordinates. Therefore, the power consumption of the digital compass with built-in accelerometer 119 or the dual accelerometer 116 may be small in comparison to the power required to operate the video encoder 100. For instance, the digital compass with built-in accelerometer 119 may consume less than or equal to about 66 milli-Watts (mW), the dual accelerometer 116 may consume less than or equal to about 15 mW, and the video encoder 100 may consume about one Watt. In some embodiments, the digital compass with built-in accelerometer 119 may comprise one KXM52 tri-axis accelerometer and a Honeywell HMC6042/1041z tri-axis compass, which may consume about 23 mW. Hence, the power consumption of the digital compass with built-in accelerometer 119 or the dual accelerometer 116 may add up to about three percent to the power needed for the video encoder 100, which may be negligible. In an embodiment, the dual accelerometers 116 may be two KXM52 tri-axis accelerometers, which may consume less than about five mW.

Typically, camera movement may be linear or rotational. Linear movement may be introduced by camera location change and rotational movement may be introduced by tilting, e.g. turning the camera vertically, or panning, e.g. turning the camera horizontally. Camera rotation may lead to significant global motion in the captured video frames. Assuming negligible linear acceleration of the camera, a single accelerometer (e.g. tri-axis accelerometer) may provide the vertical angle of the camera position with respect to the ground but not the horizontal angle. However, a single accelerometer may not provide the absolute angle of the camera device. Integrating the rotation speed or double integrating the rotational acceleration to calculate angle is impractical because it may introduce substantial sensor noise. Instead, the SaVE 120 may use the dual accelerometer 116, which may comprise two accelerometers placed apart, to measure rotation acceleration both horizontally and vertically. Specifically, a first accelerometer may provide the vertical angle and a second accelerometer may provide the horizontal angle. Additionally, a digital compass (e.g. tri-axis digital compass) may measure both horizontal and vertical angles, which may be subject to external influences, such as nearby magnets, ferromagnetic objects, and/or mobile device radio interference. Specifically, the SaVE 120 may use the digital compass with built-in accelerometer 119 to measure both vertical and horizontal angles, where a compass may provide the horizontal angle and an accelerometer may provide the vertical angle.

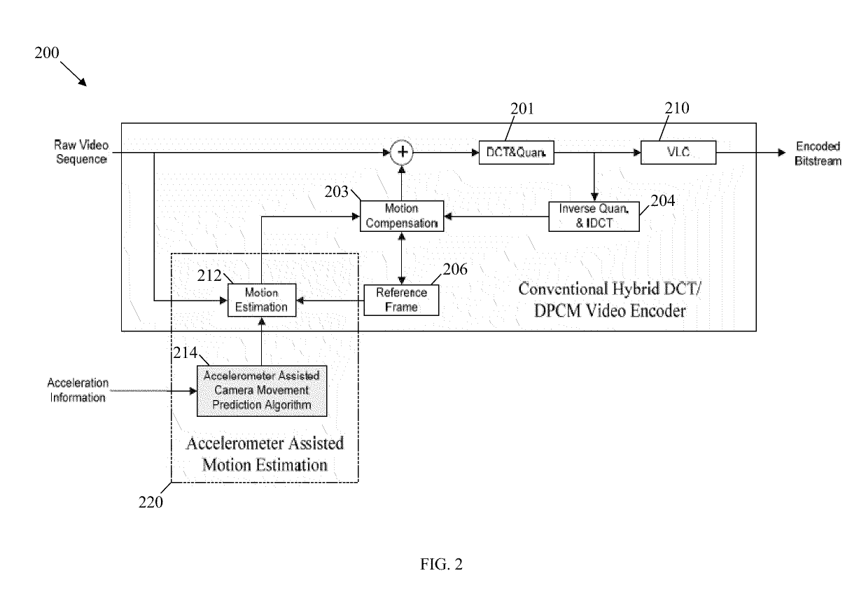

FIG. 2 illustrates an embodiment of another video encoder 200, which for example may use the MPEG-2 video encoding standard for video compression. The video encoder 200 may be positioned in a handheld camera device or a camera equipped mobile device and may comprise a plurality of components, which may be hardware, software, firmware, or combinations thereof. The components may include modules for Discrete Cosine Transform (DCT) quantization 201, motion compensation 203, inverse quantization and inverse DCT (IDCT) 204, reference frame 206, and variable length coding (VLC) 210, which may be configured to process a raw video sequence into an encoded and compressed bitstream. Additionally, the device may comprise sensors, such as accelerometers, which may be low-cost and low-power. For example, the sensors may be three-axis accelerometers such as those used in the Apple iPhone, which may consume less than about 1 mW power. Typically, the sensors may be used for more effective human-device interaction, such as in an iPhone, and for improved quality of image/video capturing, such as in Canon Image Stabilizer technology.

In MPEG-2 standard, and similarly in other standards such as H.264/MPEG-4 AVC, motion estimation may be critical for leveraging inter-frame redundancy for video compression, but may have the highest computation cost in comparison to the remaining components. For example, implementing the full search approach for motion estimation based on the MPEG-2 standard may consume about 50 percent to about 95 percent of the overall encoding time on a Pentium 4-based Personal Computer (PC), depending of the search window size. The search window size may be at least about 11 pixels to produce a video bitstream with acceptable quality, which may require about 80 percent of the overall encoding workload.

In an embodiment, the sensors of the device may be used with the components of the video encoder 200 to improve video encoding efficiency. Specifically, the camera movements may be detected using the sensors, which may be accelerometers, to improve motion vector searching in motion estimation. Accordingly, the video encoder 200 may comprise an accelerometer assisted video encoder (AAVE) 220, which may be used to reduce computation load by about two to three times and hence improve the efficiency of MPEG encoding. The AAVE 220 may comprise modules for motion estimation 212 and accelerometer assisted camera movement prediction algorithm 214. The AAVE 220 may be coupled to two three-axis accelerometers, which may accurately capture true acceleration information of the device. The module for accelerometer assisted camera movement prediction algorithm 214 may be used to convert the acceleration data into predicted vertical and horizontal motion vectors for adjacent frames, as described below. The module for motion estimation 212 may use the predicted motion vector to reduce the computation load of motion estimation for the remaining components of the video encoder 200, as explained further below. The AAVE 220 may estimate global motion in video sequences using the acceleration data and hence the search algorithm of the video encoder 200 may be configured to find only the remaining local motion for each block. Since objects in a scene typically move relatively short distances in the time period between adjacent frames, e.g. 1/25 seconds, the local motion search range may be set relatively small, which may substantially reduce computation requirements. Additionally, to further improve computation efficiency, the AAVE 220 may be used with improved searching algorithms that may be more efficient than the full search approach.

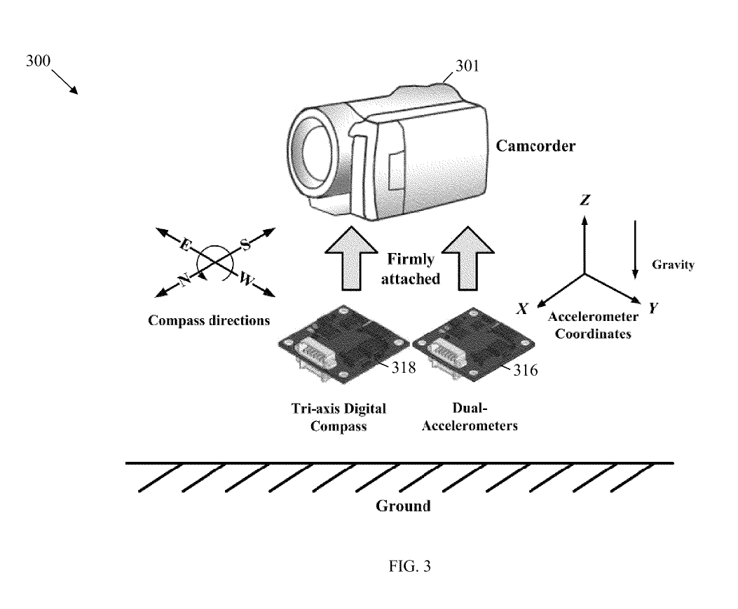

FIG. 3 illustrates an embodiment of a three orthogonal axis (aₓ, a_{y}, and a_{z}) system 300 associated with a handheld camera 301, which may comprise a video encoder configured similar to the video encoder 100. For instance, the camera 301 may comprise a dual accelerometer 316 and a tri-axis digital compass 318, which may be firmly attached to the camera 301 and used to obtain the vertical angle and horizontal angle of the camera 301. The vertical angle of the camera 301 may be calculated based on the effect of the earth's gravity on acceleration measurement in the aₓ, a_{y}, and a_{z} system. For instance, when the camera 301 rolls down from the illustrated position in FIG. 3, aₓ may increase and a_{z} may decrease. As such, the vertical angle Pₙ of the camera at the frame Fₙ may be calculated according to:

$${P}_{n} = {tan}^{- 1} \{ \frac{{a}_{x}}{\sqrt{{a}_{y}^{2} + {a}_{z}^{2}}} \} . \qquad ( 1 )$$

In equation (1), aₓ, a_{y}, and a, may be the acceleration readings from a tri-axis accelerometer in the dual accelerometer 316. Hence, the vertical rotational change Δθᵥ for two successive video frames Fₙ and Fₙ₋₁ may be calculated as according to:

ΔθᵥPₙ−Pₙ₋₁. (2)

Similarly, the horizontal angle may be calculated using the readings from the tri-axis digital compass 318. Effectively, the horizontal angle may be calculated with respect to the magnetic north instead of ground. Therefore, the horizontal rotational movement Δθₕ between Fₙ and Fₙ₋₁ may be obtained according to:

Δθₕ=Hₙ−Hₙ₋₁, (3)

where Hₙ and Hₙ₋₁ may be the horizontal angles obtained from the digital compass at frames Fₙ and Fₙ₋₁, respectively. Alternatively, the pair of accelerometers in the dual accelerometer 316 may provide information regarding relative horizontal rotational movement by sensing rotational acceleration. For instance, the horizontal rotational movement Δθₕ may be obtained according to:

Δθₕ(n)=Δθₕ(n−1)+k·(S_{0y}−S_{1y}). (4)

In equation (4), S_{0y} and S_{1y} may be the acceleration measurements in y (or a_{y}) direction from the dual accelerometers, respectively, and k may be a constant that may be directly calculated from the distance between the two accelerometers, the frame rate, and the pixel-per-degree resolution of the camera.

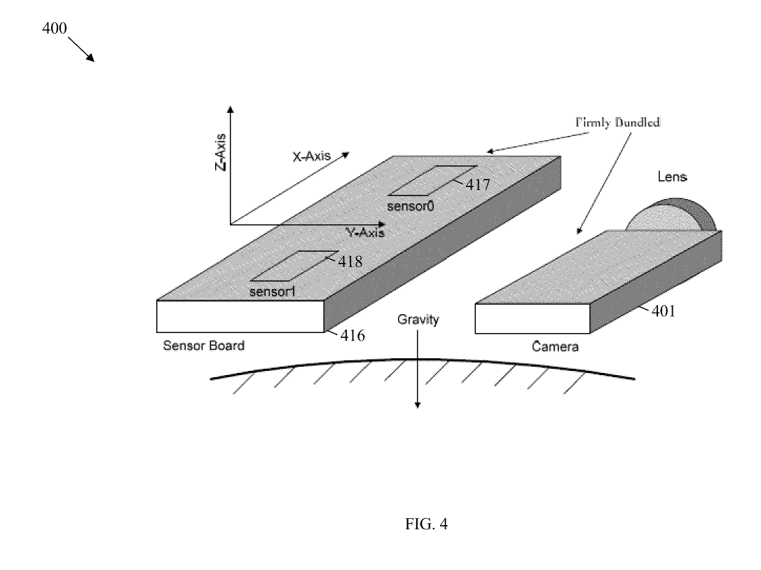

FIG. 4 illustrates an embodiment of a three orthogonal axis (X-Axis, Y-Axis, and Z-Axis) system 400 associated with a handheld camera 401, which may comprise a video encoder configured similar to the video encoder 200. The camera 401 may also be firmly bundled to a sensor board 416, which may comprise a first sensor (sensor0) 417 and a second sensor (sensor1) 418. The first sensor 417 and second sensor 418 may be two tri-axis accelerometers placed apart on the sensor board 416, which may consume less than about ten mW power and be used to provide the vertical and horizontal movements (e.g. in angles) of the camera 401, as described in detail below.

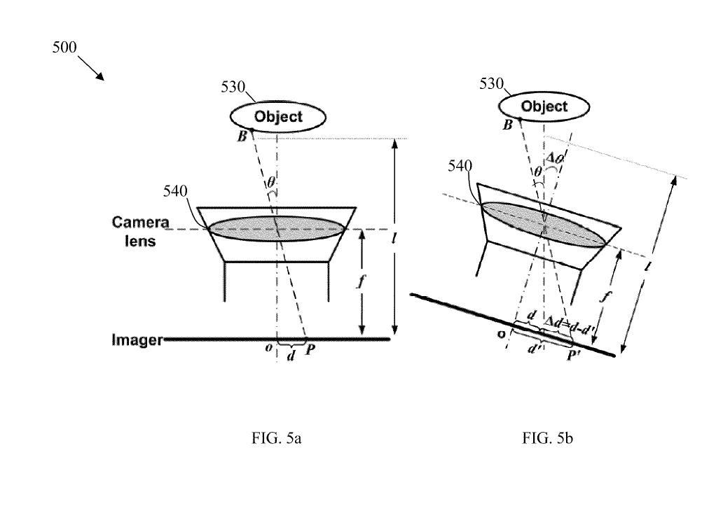

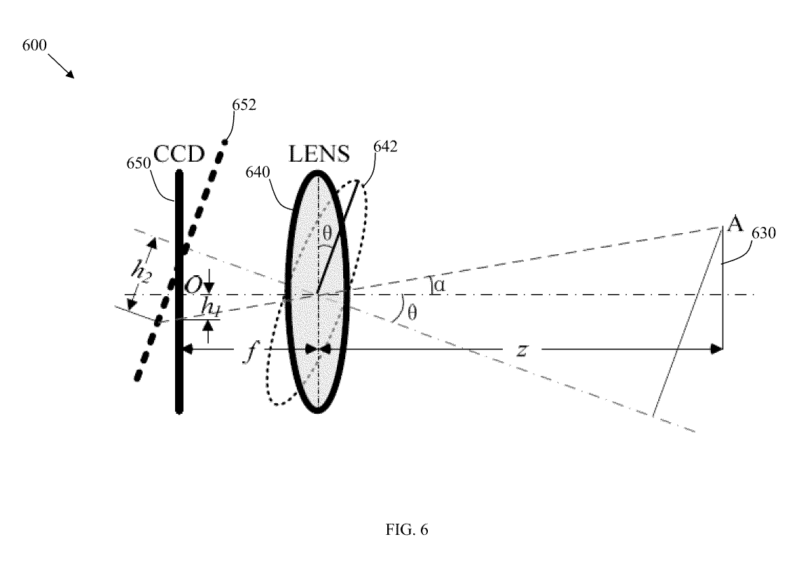

FIGS. 5a and 5b illustrate an optical model 500 for change in object positioning with respect to the movement of a camera, such as the camera 301. Specifically, FIG. 5a shows a first position of an object 530 with respect to a non-tilted position of the camera lens 540 and FIG. 5b shows a second position of the object 530 with respect to a tilted position of the camera lens 540. The first position of the object 530 may be about horizontal to the plane of the camera lens 540 and the second position of the object 530 may be rotated or tilted from the horizontal plane of the camera lens 540. When a camera rotates, the projection of the object 530 in the view to the camera image sensor may move, as shown in FIGS. 5a and 5b. The movement of the projection of the object 530 on the image sensor may be described by a global movement vector (GMV), which may specify a vertical and a horizontal movement of the object 530 in two successive frames due to camera rotation.

In an embodiment, the GMV may be calculated based on the camera characteristics and an optical model of the camera, for instance by the module for sensor-assisted camera movement estimation 114. In FIGS. 5a and 5b, the optical center of the camera image sensor may be denoted by O, the focal length of the camera lens 540 may be denoted by f, the distance between the object 530 and the camera 540 may be denoted by l, and a point in the object 530 may be denoted by B. In FIG. 5a, a projection P of point B on the image sensor may be located at a first distance d from O, and θ may be the angle between the line BP and the perpendicular bisector of the camera lens 540. In FIG. 5b, the camera is turned by an angle difference of Δθ, and hence a new projection P′ of point B may be located at a second distance d′ from O. The movement of projections of point B on the image sensor, e.g. for horizontal or vertical movement, may be calculated as Δd=d−d′. From the optical model, d and d′ may be calculated according to:

$$\{ \begin{matrix}d = f \cdot tan θ , \\ {d}^{′} = f \cdot tan ( θ + Δ θ ) .\end{matrix} \qquad ( 5 )$$

Hence, the movement for projections Δd may be calculated according to:

Δd=d−d′=f·{tan(θ+Δθ)−tan θ}. (6)

Typically, Δθ may be small or negligible between two successive frames of a video clip, and therefore equation (6) may be further simplified according to:

$$tan ( θ + Δ θ ) - tan θ \approx Δ θ \cdot \frac{d ( tan θ )}{d θ} = Δ θ \cdot {sec}^{2} ( θ ) . \qquad ( 7 )$$

As such, Δθ may be obtained according to:

Δd≈f·Δθ·sec²(θ). (8)

Further, Δθ may range between about zero and about half of the Field of View (FOV) of the camera lens 540. For many types of camera lenses, except for extreme wide-angle and fisheye lenses, θ may be small enough and Δd may be calculated according to:

Δd≈f·Δθ·sec²(θ)≈f·Δθ. (9)

From the equations above, the movement of the projection along the vertical direction Δdᵥ and the movement of the projection along the horizontal direction Δdₕ of the object 530, which may be associated with the camera rotational movements, may be calculated similarly using f and Δθ. The calculated value off may then be converted into pixels by dividing the calculated distance by the pixel pitch of the image sensor, which may be denoted by f. The focal lens f of the camera and the pixel pitch of the image sensor may be intrinsic parameters of the camera, and may be predetermined without the need for additional computations. For instance, the intrinsic parameters may be provided by the manufacturer of the camera. The horizontal and vertical movements Δdₕ and Δdᵥ, respectively, may be used to calculate the GMV for two successive frames Fₙ and Fₙ₋₁ according to:

GMVₙ(Δdₕ,Δdᵥ)=(f′·Δθₕ,f′·Δθᵥ). (10)

In an embodiment, the SaVE 120 may dynamically calculate a plurality of GMVs dependent on a plurality of reference frames. For instance, in the H.264/AVC standard, a single GMV calculated for a video frame Fₙ from its previous reference frame Fₙ₋₁ may not provide accurate predictors in other reference frames, and therefore multiple-reference-frame motion vector prediction may be needed. For example, using the frame Fₙ₋₁ as the reference frame, the GMVₙ^{k} for the frame Fₙ may be calculated according to:

$${GMV}_{n}^{k} ( Δ {d}_{h} , Δ {d}_{v} ) = {\sum }_{i = n - k}^{n} {GMV}_{i} . \qquad ( 11 )$$

As such, using dynamic GMVs may allow motion estimation to be started from different positions for different reference frames.

In an embodiment, to improve motion estimation, the SaVE 120 may use the calculated GMV(Δdₕ,Δdᵥ) value in the UMHS and EPZS algorithms as a predictor (SPx,SPy). The SaVE predictor may be first attempted in the algorithms before using UMHS and EPZS predictors, e.g. conventional UMHS and EPZS predictors. The SaVE predictors may be defined according to:

$$\{ \begin{matrix}SPx = x + Δ {d}_{h} , \\ SPy = y + Δ {d}_{v} ,\end{matrix} \qquad ( 12 )$$

where x and y may be the horizontal and vertical coordinates, respectively, of the current block to be encoded. In an embodiment, an Arbitrary Strategy may be adopted for using the SaVE predictors as the initial search position in the motion estimation algorithms. The Arbitrary Strategy may use the SaVE predictors as initial predictors for all macro-blocks in a video frame. The drawback of the Arbitrary Strategy may be that it may excessively emphasize on the measured global motion while ignoring the local motion and the correlations between spatially adjacent blocks. Thus, the Arbitrary Strategy may not provide substantial gain over UMHS and EPZS.

Alternatively, a Selective Strategy that considers both global and local motion may be adopted for the SaVE predictors. The Selective Strategy may be based on examining many insertion strategies, e.g. attempting the insertion with different number of blocks and different locations of the picture. The Selective Strategy may insert the SaVE predictors into the top and left boundary of a video picture. Accordingly, UMHS and EPZS predictors may spread the current motion vector tendency to the remaining blocks in the lower and right part of the video picture, since they may substantially rely on the top and left neighbors of the current block. As a result, the Selective Strategy may spread the global motion estimated from sensors to the entire video picture. For instance, the macro-block located at the i^{th} column and j^{th} row in a video picture may be denoted by MB_{(i,j)} (where MB_{(0,0)} may be regarded as the top-left macro-block). The Selective Strategy may use the SaVE predictors as the initial search position when i or j is less than n, where n is an integer that may be determined empirically. For example, the value of n equal to about two may be used. Otherwise, UMHS and EPZS predictors may be used if the condition above is not satisfied, e.g. when i and j are greater than n. The Selective strategy may improve UMHS/EPZS performance since it uses the SaVE predictors, which may reflect the global motion estimated from sensors, and respects the spatial correlations of adjacent blocks by using UMHS and EPZS predictors.

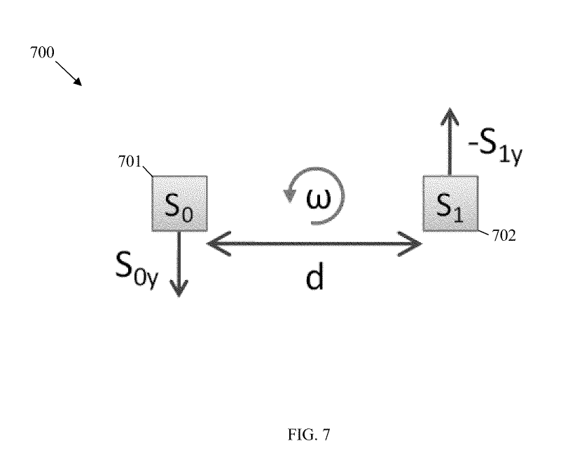

FIG. 6 illustrates an optical model 600 for change in object positioning with respect to the movement of a camera, such as the camera 401. Specifically, FIG. 6 shows a first position of an object 630 with respect to a non-tilted position 640 of the camera lens and a second position of the object 630 with respect to a tilted position 642 of the camera lens. The first position of the object 630 may be about horizontal to the plane of the camera lens 640 and the second position of the object 630 may be rotated or tilted from the horizontal plane of the camera lens 640. The change in the angle of the camera may result in the movement of the captured image of the object 630 in the camera's charge-coupled device (CCD) 650.

The object 630 in line of view of the camera may be denoted by A, the distance of the object 630 from the camera lens may be denoted by z, and the optical center of the CCD 650 may be dented by O. The projection of A on the CCD 650 may be located at a distance h₁ from O. When the camera lens rotates by an angle difference θ, the new projection of A on a rotated CCD 652 may be located at h₂ from the center of the CCD 652. To predict the motion vector, the object movement in the CCD or the image movement (h₂−h₁) due to the rotation (θ) may be calculated, instance by the module for accelerometer assisted camera movement prediction algorithm 214. Based on the camera's focal length, which may be denoted by f, a geometric optical analysis may lead to h₁=f·tan α and to h₂=f·tan(α+θ), similar to equations 5. Hence, the image movement may be obtained by Δh=h₂−h₁=f·{tan(α+θ)−tan α}, similar to equation 6. As shown above, for relatively small angles and limited angle differences θ in the FOV, the image movement may be approximated by Δh≈f·θ·sec²(α)≈f·θ, similar to equation 9. Therefore, the optical model parameters f and θ may be sufficient to estimate the image movement. The movement in pixels may then be calculated by dividing the calculated distance by the pixel pitch of the CCD.

Both f and the pixel pitch may be intrinsic parameters of the optical model, for example which may be predetermined from the manufacturer. However, the angle difference θ due to rotation of the camera may be obtained from the accelerometers. A single three-axis accelerometer may be sufficient for providing the vertical movement of the camera, where the effect of the earth's gravity on acceleration measurements in three axes may be utilized to calculate the static angle of the camera. For instance, when the camera rolls down from the vertical angle α of the camera may be calculated using equation 1. The vertical angle difference θᵥ may then be obtained by deducting the measured angle of two subsequent frames (n, n−1), such as θᵥ=αₙ−αₙ₋₁, and the vertical image movement may be obtained according to Δhᵥ=f·θᵥ=f·αₙ−αₙ₋₁.

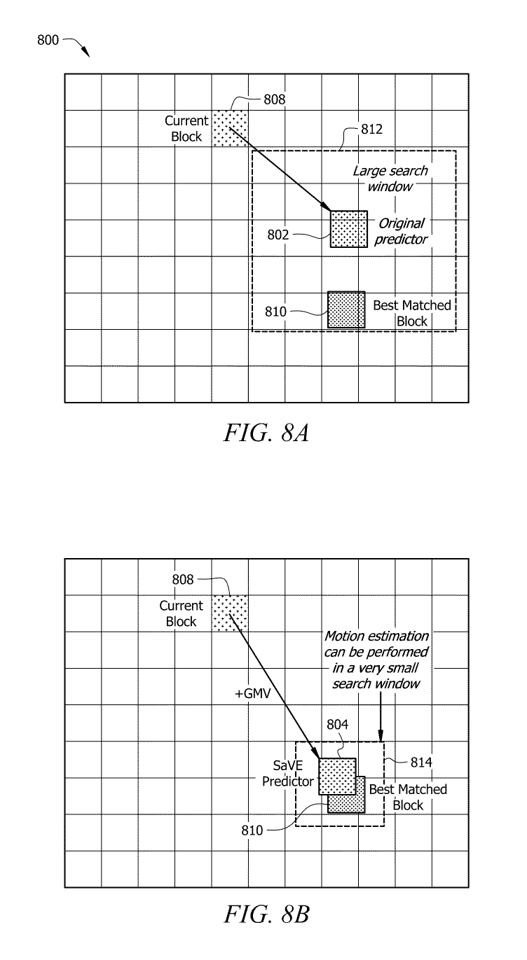

FIG. 7 illustrates a dual accelerometer configuration 700, which may be used to provide the horizontal angle difference θₕ due to horizontal camera rotation. For instance, the dual accelerometer configuration 700 may be used in the sensor board 416 coupled to the camera 401. The angular acceleration of the camera device in the horizontal direction may be calculated using measurements from a first accelerometer 701 (S₀) and a second accelerometer 702 (S₁), which may be separated by a distance d, according to

$${ω}^{′} = \frac{{S}_{0 y} - {S}_{1 y}}{d} ,$$

where S_{0y} and S_{1y} may be the acceleration measurements in the y direction perpendicular to the plane between the first accelerometer 701 and second accelerometer 702. Assuming the time between to subsequent frames is t, the horizontal angle difference θₕ may be defined as θₕ=ω·t, where ω is the angular velocity of the camera device. The horizontal angle difference θₕ between the frames n and n−1 may then be calculated by differentiating the expression for θₕ according to the following mathematical steps:

$${θ}_{h}^{′} = \frac{{θ}_{h} ( n ) - {θ}_{h} ( n - 1 )}{t} = {ω}^{′} \cdot t , \\ {θ}_{h} ( n ) - {θ}_{h} ( n - 1 ) = \frac{{S}_{0 y} - {S}_{1 y}}{d} \cdot {t}^{2} , \\ {θ}_{h} ( n ) - {θ}_{h} ( n - 1 ) = k \cdot ( {S}_{0 y} - {S}_{1 y} ) ,$$

where

$$k = \frac{{t}^{2}}{d} .$$

As such, the horizontal angle difference θₕ for the frame n may be obtained according to θₕ(n)=θₕ(n−1)+k·(S_{0y}−S_{1y}). Using the horizontal angle difference θₕ for each frame, the horizontal image movement or motion vector Δhₕ for the n^{th} frame may be calculated from that of the previous frame (e.g. Δhₕ(n−1)) and the dual accelerometer readings according to Δhₕ=Δhₕ (n)=Δhₕ(n−1)+k′·(S_{0y}−S_{1y}). For example, the horizontal image movement or motion vector may be calculated using the accelerometer assisted camera movement prediction algorithm 214. The motion vector of the previous frame may be known when encoding the current frame and the values of S_{0y} and S_{1y} may be obtained from the sensor readings. The value of the variable k′ may be calculated based on the frame rate, focal distance, pixel pitch of the camera, and the distance d. In an alternative embodiment, the value of Δhₕ may be calculated from θₕ, which may be obtained using a gyroscope instead of two accelerometers. The gyroscope may be built in some cameras for image stabilization.

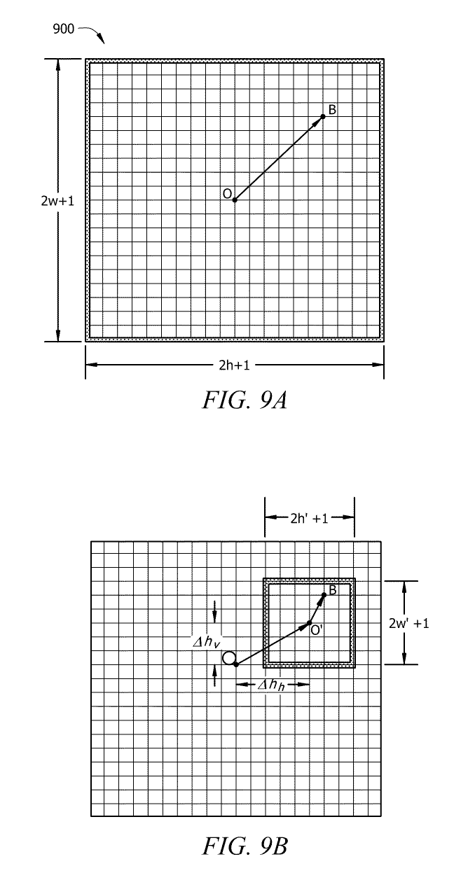

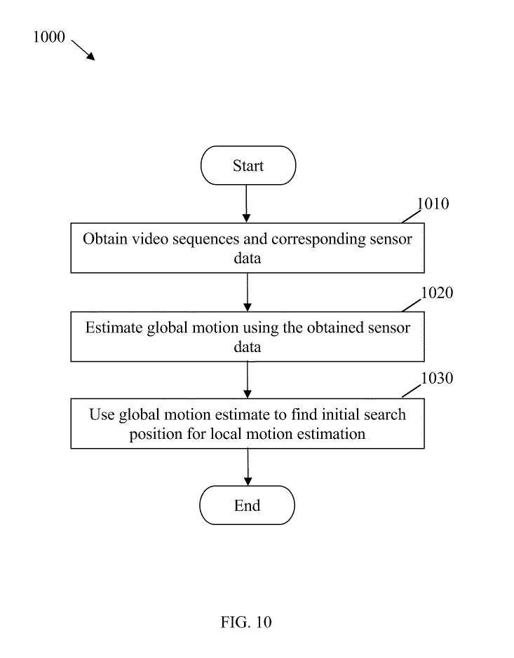

FIGS. 8a and 8b illustrate predictors that may be used to improve motion estimation, for instance by the module for motion estimation 112. Specifically, FIG. 8a shows a first predictor 802, which may be a conventional or original UMHS predictor, and FIG. 8b shows a second predictor 804, which may be a SaVE predictor obtained as described above and used by the SaVE 120 in the camera. In FIG. 8a, the first predictor 802 may start motion estimation from a neighboring vector of the current block 808. As such, the first predictor 802 may be closer to the best matched block 810 than the current block 808 and may require a first search window 812 that may be smaller than the entire frame to identify the best matched block 810. Since, the first predictor 802 may not be based on knowledge of global motion, the first search window 812 may not be substantially small (e.g. when the video clip contains fast camera movement), and thus the search may still require substantial computation time. To reduce the first search window 812, one of various GME methods described herein may be used by obtaining an initial position for local motion estimation. In FIG. 8b, the second predictor 804 may start motion estimation from a calculated GMV vector based on knowledge of global motion, which may be obtained from sensor data. Consequently, the second predictor 804 may be closer to the best matched block 810 than the first predictor 802 and hence may require a second search window 814 that is smaller than the first search window 812 to identify the best matched block 810. Additionally, one of the GME methods described herein may be used to further reduce the second search window 814 and reduce computation time.

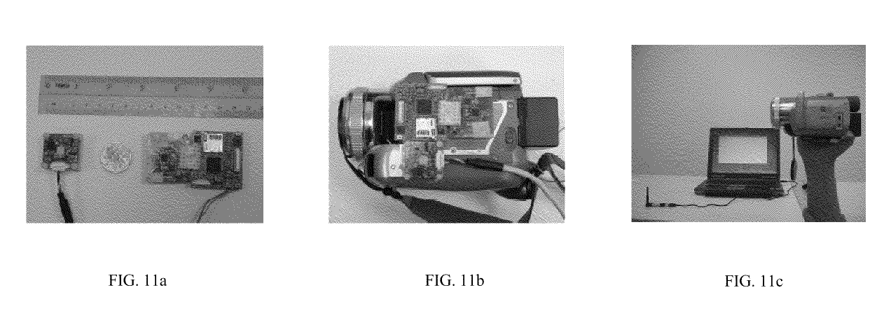

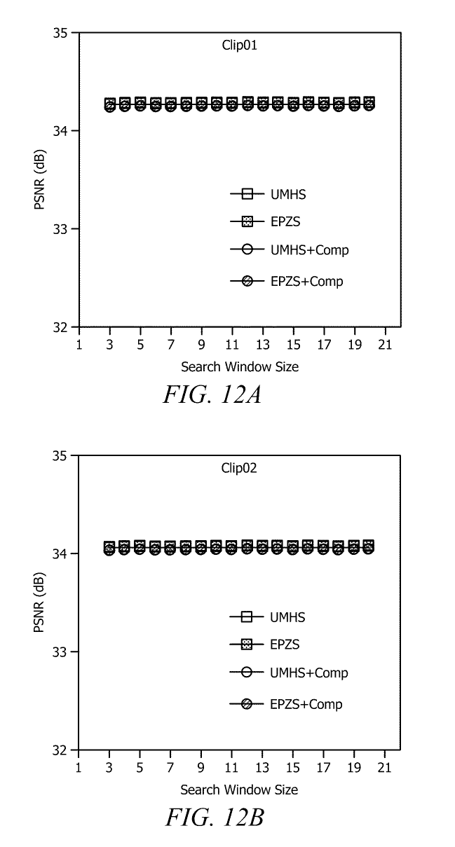

FIGS. 9a and 9b illustrate motion estimation using image movements calculated from sensor data, for instance at the module for motion estimation 212. Specifically, FIG. 9a shows motion estimation without using the calculated image movements from sensor data. For instance, a full search approach may be used, which may have a search window that comprises the entire frame. The search window and the frame may have a width equal to about 2w+1 pixels and a height equal to about 2h+1 pixels. The full search may start from the top-left corner of the block with the coordinate O in the reference frame, and then proceeds through the search window of (2w+1)×(2h+1) pixels to locate the optimal prediction block B.

FIG. 9b shows motion estimation based on the calculated image movements from two accelerometers. For instance, the motion estimation may be used the AAVE 220 in the camera 401 and the dual accelerometer configuration 700. The calculated vertical and horizontal movements Δhᵥ and Δhₕ, respectively, may be used to simplify the motion estimation procedure in video encoding by reducing the motion search window size. The calculated image movements may be direct result to camera movement and thus may be estimate the global motion in the video images. If Δhᵥ and Δhₕ are absolutely accurate and the objects are static, the search window size may be reduced to a single pixel since (Δhᵥ,Δhₕ) may be the exact motion vector. However, since (Δhᵥ,Δhₕ) may be approximated based on acceleration data from the sensors and since the objects in the camera view may move, the search window size may be greater than one pixel. But substantially smaller than the search window using the full search approach. Using the values calculated from sensor data, the image may be estimated to be displaced by about (Δhᵥ,Δhₕ) due to camera movement. Therefore, motion estimation may be started from O′ in the reference frame, which may be displaced by about (Δhᵥ,Δhₕ) pixels from O and substantially closer to B. As such, a substantially smaller search window of about (2w′+1)×(2h′+1) pixels may be needed to locate the optimal prediction block.

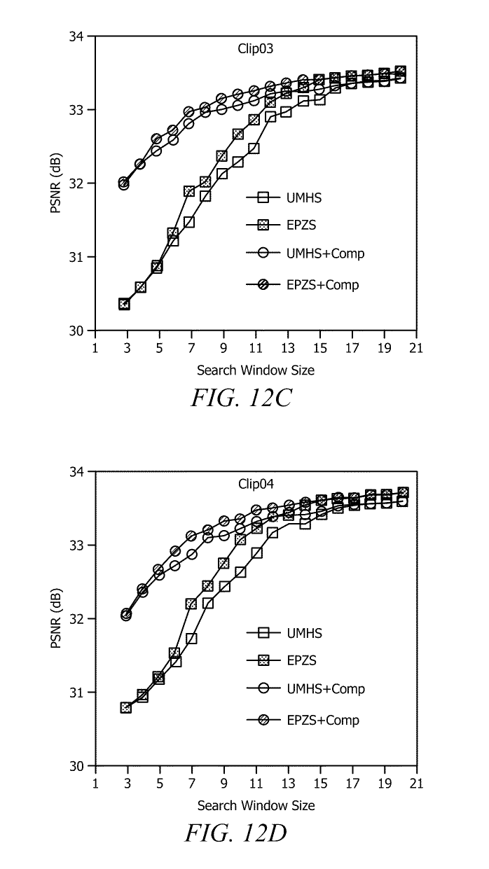

FIG. 10 illustrates an embodiment of a sensor-assisted motion estimation method 1000, which may use sensor data to estimate global motion. At block 1010, the video sequences and the corresponding sensor data may be obtained. For instance, the video sequences may be captured using a camera and the sensor data may be detected using the sensors coupled to the camera, such as on a sensor board. For example, the camera may be similar to the camera 301 and may comprise a video encoder similar to the video encoder 100, which may be coupled to two sensors, such as the dual accelerometers 116 and the digital compass with built-in accelerometer 118. The detected sensor data may comprise the vertical angle of a frame and the vertical rotational or angular change between consecutive frames, which may be obtained by a single accelerometer. The detected sensor data may also comprise horizontal rotational or angular movements, which may be obtained using two accelerometers, a digital compass, other sensors, such as a gyroscope, or combinations thereof. In another embodiment, the camera may be similar to the camera 401 and may comprise a video encoder similar to the video encoder 200 and a sensor board 416 comprising two accelerometers, e.g. similar to the dual accelerometer configuration 700. The two accelerometers may provide both the vertical and horizontal angular movements of the camera.

Next, at block 1020, global motion may be estimated using the obtained sensor data. For instance, the vertical and horizontal movements of the object in the camera image may be calculated using the vertical and horizontal angular movements, respectively. The estimated vertical and horizontal movements may be estimated in pixels and may be converted to motion vector or predictors, which may be suitable for searching the frames to estimate local motion. At block 1030, the global motion estimates, e.g. the motion vectors or predictors, may be used to find initial search position for local motion estimation. Specifically, the motion vectors or predictors may be used to begin the search substantially closer to the best matched block or optimal motion vector and to substantially reduce the search window in the frame. Consequently, estimating global motion using sensor data before searching for the best matched block or optimal motion vector may reduce the computation time and cost needed for estimating local motion, and hence improve the efficiency of overall motion estimation. Effectively, estimating global motion initially may limit the motion estimation search procedure to finding or estimating the local motion in the frames, which may substantially reduce the complexity of the search procedure and motion estimation in video encoding.

In alternative embodiments, different quantities and/or types of sensors or sensor boards may be coupled to the camera and used to obtain the sensor data for global motion estimation. For example, two dual tri-axis accelerometers, each comprising two accelerometers, may be used to obtain the vertical angle and horizontal angle of the camera and hence calculate the corresponding motion vectors or predictors. Alternatively, the sensor data may be obtained using a single tri-axis compass or using a two-axis compass with possibly reduced accuracy. Other sensor configurations may comprise a two-axis or three-axis compass and a two-axis or three-axis three-axis compass. In another embodiment, a two-axis gyroscope may be used to obtain the sensor data for calculating the motion vectors or predictors. In an embodiment, a sensor may be used to obtain sensor data for reducing the search window size in one direction instead of two directions, e.g. in the vertical direction. For example, a single tri-axis or two-axis accelerometer may be coupled to the camera and used to obtain the vertical angle, and thus a vertical motion vector that reduces the search window size in the vertical direction but not the horizontal direction. Using such configuration may not provide the same amount of computation benefit in comparison to the other configurations above, but may still reduce the computation time at a lower cost.

In an embodiment, motion estimation based on calculated motion vectors or predictors from sensor data may be applied to inter-frames, such as predictive frames (P-) and bi-predictive frames (B-) and other (conventional) motion estimation methods may be applied for intra-frames. After estimating global motion using the calculated values, local motion may be estimated using a full search approach or other improved motion estimation search techniques to produce an optimal motion vector. The blocks in the same frame may have the same initial center for the search window. However, for different frames, the center of the search window may be different and may be predicted from the corresponding sensor data.

### EXAMPLES

The invention having been generally described, the following examples are given as particular embodiments of the invention and to demonstrate the practice and advantages thereof. It is understood that the examples are given by way of illustration and are not intended to limit the specification of the claims in any manner.

### Example 1

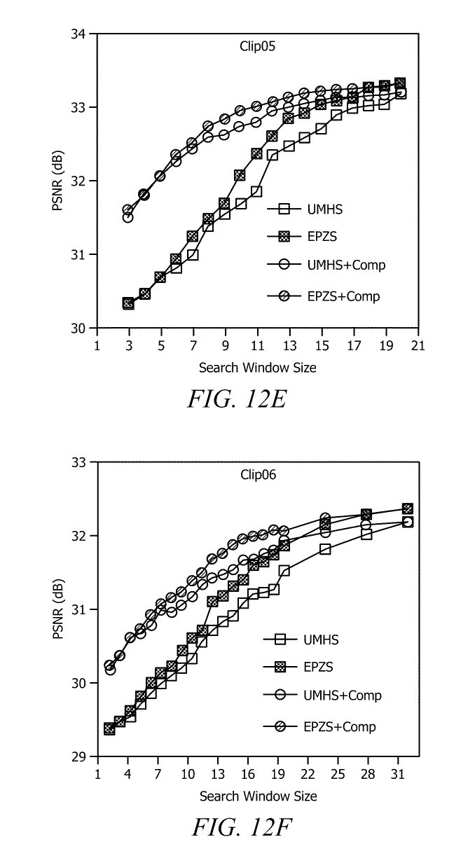

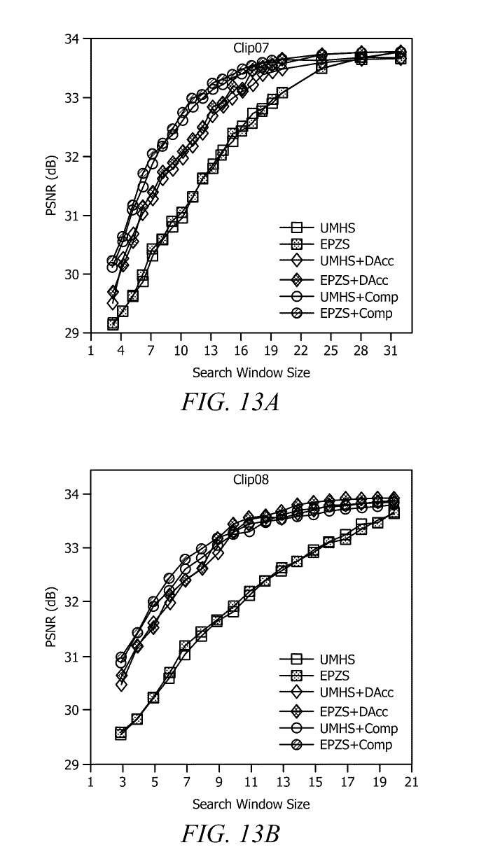

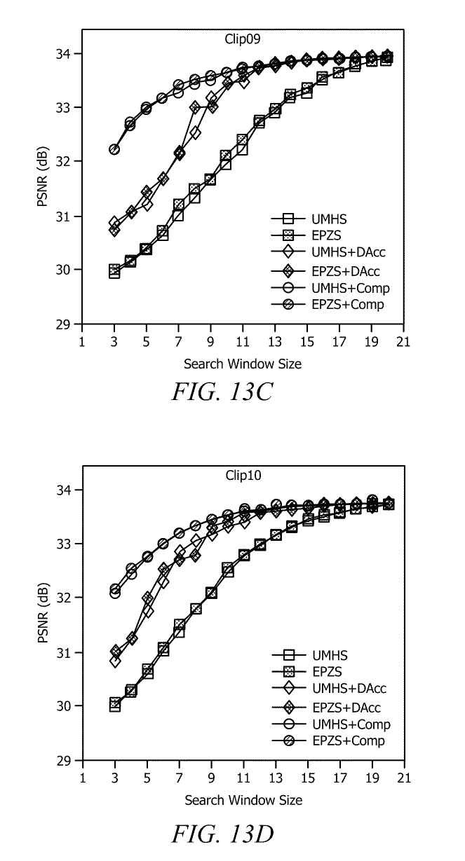

FIGS. 11a, 11b, and 11c illustrate a SaVE prototype coupled to a camera, which may comprise a video encoder similar to the video encoder 100. FIG. 11a shows the components of the SaVE prototype, which may comprise two sensor boards. One of the sensor boards was custom designed and carries dual tri-axis accelerometers. The other sensor board is an OS5000 board from OceanServer Technology, which is a commercial tri-axis digital compass with an embedded tri-axis accelerometer. The commercial sensor is configured to compute and report the absolute horizontal and vertical angles using its tri-axis compass and tri-axis accelerometer, respectively. The custom sensor is configured to produce raw accelerometer readings, which are then processed offline to calculate the vertical and horizontal angles. The SaVE was used with both boards, denoted as SaVE/DAcc using dual accelerometers and SaVE/Comp using the digital compass.

FIG. 11b shows a camcorder that was firmly attached to the two sensor boards, such that the sensor boards and the camcorder lens are aligned in the same direction. The camcorder has a resolution of about 576×480 pixels, and its frame rate was set to about 25 frames per second (fps). The camcorder does not support raw video sequence format, and therefore the captured video sequences were converted into the YUV format with software. The camcorder was used to capture about 12 video clips with different combinations of global (camera) and local (object) motions, as shown in Table 1.

TABLE 1
Video Sequences

Object

| Camera | Still | Moving |
|---|---|---|
| Keep almost still | Clip01 | Clip02 |
| Slow Vertical Movement | Clip03 | Clip04 |
| Fast Vertical Movement | Clip05 | Clip06 |
| Slow Horizontal Movement | Clip07 | Clip08 |
| Fast Horizontal Movement | Clip09 | Clip10 |
| Irregular Movement | Clip11 | Clip12 |

The sensor data were collected while capturing the video clips and then synchronized manually because the hardware prototype is limited in that the video and its corresponding sensor data are provided separately. The video was captured directly by the camcorder and the sensor data were captured directly by the digital compass and the accelerometers. FIG. 11c shows a laptop connected to the camcorder that was used to store both the video and sensor data. The synchronization between the dual accelerometers and video clips was achieved for each recording by applying a quick and moderate punch to the camcorder before and after recording. The punch produces a visible scene glitch in the video sequence and a visible jolt in the sensor data. The glitch and the jolt are assumed to be synchronized, and hence the remaining video sequences and sensor data are manually synchronized according to the sample rate of the sensor board and the frame rate of the camcorder. For the digital compass, the maximum recorder angle was aligned with the frame taken at largest vertical angle in a video clip. This manual integration may not be required in an integrated hardware implementation. Instead, it may be straightforward to synchronize video and sensor readings, e.g. the sensor data recording and video capturing may start simultaneously when a user presses the Record button of a camcorder or mobile device.

The SaVE prototype uses a standard H.264/AVC encoder (version JM 142), which implements up-to-date UMHS and EPZS algorithms. For each predictive frame (P- and B-frame), SaVE predictors in UMHS and EPZS may be used with the Selective Insertion Strategy (n=2). Each sequence is then encoded using Baseline profile with variable block sizes and about five reference frames. The Rate Distortion Optimization (RDO) is also turned on. A Group of Picture (GOP) of about ten frames is used in the encoding. The first frame of each GOP is encoded as an I-frame and the remaining nine frames are encoded as P-frames. Each sequence was cut to about 250 frames (about ten seconds for about 25 fps). All sequences were encoded with a fixed bitrate at about 1.5 Megabits per second (Mbps). For each sequence, the original encoder is expected to produce bitstreams with the same bitrate and different video quality when the search window size (SWS) varies. A larger search window may produce smaller residual error in motion estimation and thus better overall video quality.

Each video clip collected with the hardware prototype is encoded with original UMHS and EPZS, and the enhanced algorithms are encoded with SaVE predictors, e.g. UMHS+DAcc, UMHS+Comp, EPZS+DAcc, EPZS+Comp, where “+DAcc” and “+Comp” refer to SaVE predictors obtained by SaVE/DAcc and SaVE/Comp, respectively. The SWS ranges from about ±3 pixels to about ±32 pixels (denoted as SWS=3 to SWS=32). All encodings were carried on a PC with a 2.66 Giga Hertz (GHz) Intel Core 2 Duo Processor and about four Giga Bytes (GB) memory.

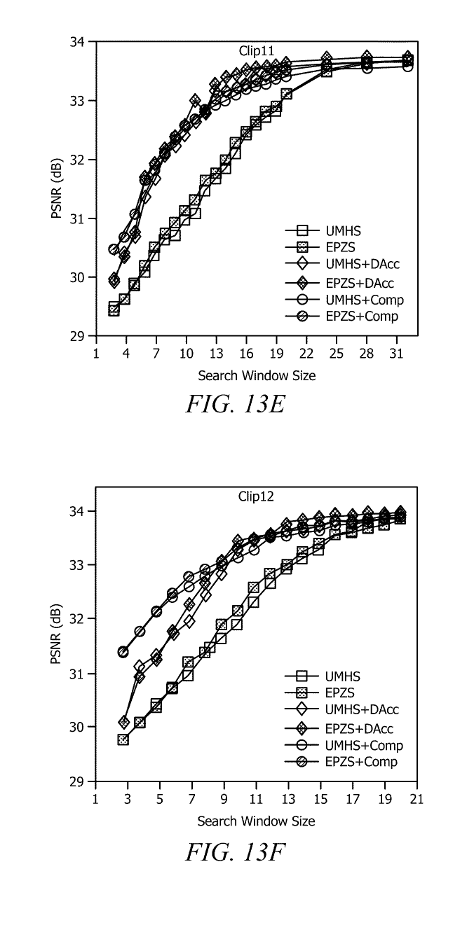

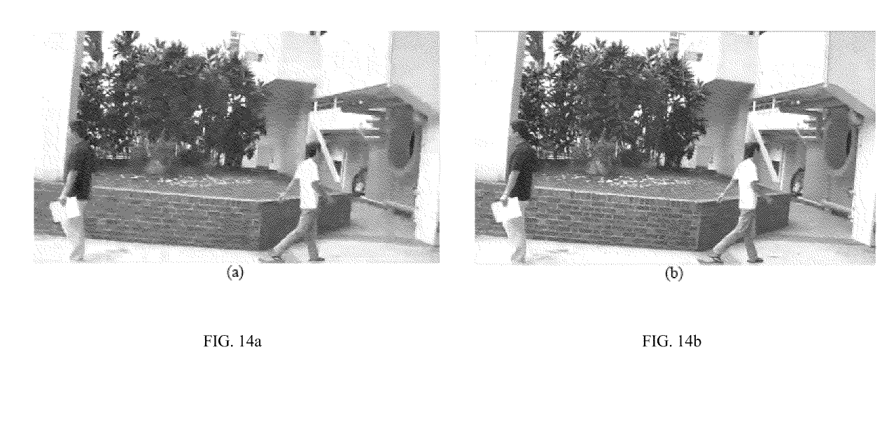

FIG. 12 and FIG. 13 show the Peak Signal-to-Noise Ration (PSNR) gains obtained by SaVE in comparison to the original H.264/AVC encoder with UMHS and EPZS. Specifically, FIG. 12 shows a plurality of PSNR plots for clips with vertical movement and FIG. 13 shows a plurality of the PSNR plots for clips with horizontal movement. The PSNR is an objective measurement of video quality, where a higher PSNR may indicate a higher quality. For clips with only vertical movement, the results presented are obtained using SaVE/Comp, since both the SaVE/DAcc and SaVE/Comp use a single accelerometer to calculate the vertical rotation. For clips containing horizontal movement, the results presented are obtained using both SaVE/DAcc and SaVE/Comp. For CLIP06, Clip07, and Clip11, the results for SWS=3 to 31 are shown. For other clips, the results for SWS=3 to 20 are presented, since the SaVE prototype does not provide gains over the remaining range.

Clip01 and Clip02 were captured with the camera held still. None of the SaVE-enhanced algorithms may help in achieving higher PSNR as there is no camera rotation and thus no substantial global motion. However, the SaVE does not hurt the performance in such cases. Clip03, Clip04, Clip05, and Clip06 were captured with the camera moving vertically. With the sane SWS, the PSNRs obtained by UMHS+Comp and EPZS+Comp are clearly higher than those of the original UMHS and EPZS, especially for small SWSs. For example, when SWS=5, the PSNR gains obtained by UMHS+Comp over UMHS are 1.61 decibel (dB), 1.40 dB, 1.38 dB, and 1.05 dB for Clip03, Clip04, Clip05, and Clip06, respectively. When SWS=11, the gains by EPZS+Comp over EPZS are 0.40 dB, 0.25 dB, 0.65 dB, and 0.78 dB, respectively. UMHS+Comp and EPZS+Comp may maintain superior PSNR performance over the original algorithms until SWS is greater than or equal to about 16 for Clip03 and Clip04, until SWS is greater than or equal to about 19 for Clip05, and until SWS is greater than or equal to about 28 for Clip06.

Clip07, Clip08, Clip09, Clip10, and Clip11 were captured with the camera moving horizontally. The associated SaVE/DAcc and SaVE/Comp were evaluated and both methods were found to achieve substantial improvement over the original algorithms. For SaVE//Comp, the gains by UMHS+Comp over UMHS may be up to bout 2.59 dB for Clip09 (when SWS=5). According to the results, SaVE may obtain gains when a smaller SWS is used. For larger SWS, e.g. 11, UMHS+Comp still can achieve more than about one dB improvement for most of the clips. For SaVE/DAcc, the performance of UMHS+DAcc and EPZS+DAcc may be close to UMHS+Comp and EPZS+Comp in some cases, e.g. for Clip08. But for clips with faster camera movement, such as Clip09 and Clip10, it appears that the benefits of using UMHS+Comp and EPZS+Comp are obvious, especially at a small SWS.

Clip11 and Clip12 were captured with irregular and random movements (real-world video capturing scenario). FIG. 13 shows that the SaVE-enhanced algorithms may achieve substantial PSNR gains over the original algorithms when SWS is less than or equal to about 24 (for Clip11) or when SWS is less than or equal to about 18 (for Clip12). When medium SWSs are used, the PSNR gains are usually from about 1.0 dB to 1.5 dB for Clip11 and 0.4 dB to 1.6 dB for Clip 12.

The above results may show that, with the current prototype, SaVE may provide reasonable PSNR gains when SWS is less than or equal to about 20 for most clips. When larger SWSs (e.g. about 24 to about 32) are used, SaVE may only show a reduced improvement for Clip06, Clip07, and Clip11. However, these results show the potential of the SaVE scheme and the performance is expected to improve with an industrial implementation.

### Example 2

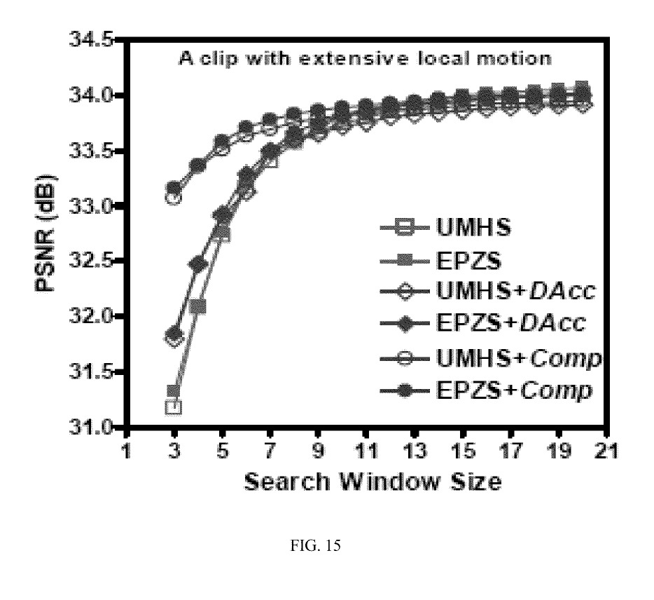

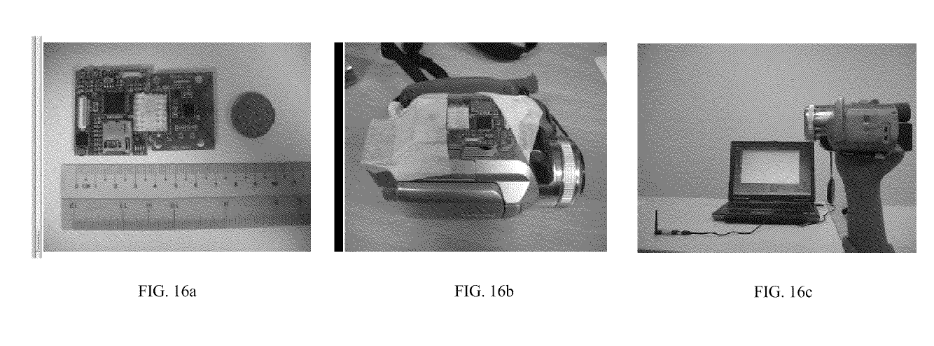

FIGS. 14a and 14b illustrate two examples for decoded pictures that correspond to frame 76 of Clip11. FIG. 14a shows a first decoded picture by EPZS (27.01 dB) and FIG. 14b shows a second decoded picture by EPZS+Comp (31.42 dB) with the same SWS=11. Due to the camera movement, the first decoded picture by EPZS is highly blurred. However, the second decoded picture using the SaVE scheme has substantially better quality. Since the estimated global motion may be well utilized, the SaVE predictor may be closer to the real predictor than other predictors. Hence, in rate-distortion optimized motion estimation, SaVE may be produce smaller block sum absolute difference (SAD) and reduce the MCOST, which may be the block SAD plus the motion vector encoding cost. Therefore, the SaVE may obtain a higher PSNR at a given SWS.

To evaluate the computation reduction using SaVE, the computation load of encoding may be measured with the motion estimation time. The motion estimation time of UMHS and EPZS may increase as SWS increases. The SaVE-enhanced algorithms using a small SWS may achieve the same PSNR of the original algorithms using a substantially larger SWS, as shown in the examples of FIG. 12 and FIG. 13. As such, the motion estimation time may be practically reduced by reducing the SWS while maintaining the same video quality. Table 2 shows for clips with vertical movements (Clip03 to Clip06) the speedup achieved by UMHS+Comp and EPZS+Comp over the original algorithms while obtaining the same or even higher PSNR. Specifically, the speedup is shown for a substantially small SWS=3 case and a relatively large SWS=11 case for SaVE-enhanced algorithms. The “CSWS” in Table 2 denotes the Corresponding SWS used in the original UMHS (EPZS) that is capable of providing the similar PSNR to UMHS+Comp (EPZS+Comp) using SWS=3 or SWS=11. The UMHS+Comp with SWS=3 may obtain higher PSNR than the original UMHS with SWS=7 to 9. This result may indicate up to about 26.59 percent saving in motion estimation time.

TABLE 2
CSWS, PSNR Gains, and Speedup achieved by SaVE-enhanced
UMHS and EPZS for clips with vertical movement
SaVE-enhanced UMHS

| | | | | UMHS + Comp (SWS = 11) | | |
|---|---|---|---|---|---|---|
| | UMHS + Comp (SWS = 3) | | | | PSNR | |
| | | PSNR | Speedup | | Gains | Speedup |
| Clip | CSWS | Gains (dB) | (%) | CSWS | (dB) | (%) |
| 03 | 8 | +0.16 | +23.62 | 14 | +0.01 | +7.98 |
| 04 | 7 | +0.30 | +14.70 | 14 | +0.03 | +7.28 |
| 05 | 8 | +0.12 | +23.71 | 15 | +0.10 | +8.00 |
| 06 | 9 | +0.08 | +26.59 | 16 | +0.09 | +8.94 |

SaVE-enhanced EPZS

| | | | | EPZS + Comp (SWS = 11) | | |
|---|---|---|---|---|---|---|
| | EPZS + Comp (SWS = 3) | | | | PSNR | |
| | | PSNR | Speedup | | Gains | Speedup |
| Clip | CSWS | Gains (dB) | (%) | CSWS | (dB) | (%) |
| 03 | 8 | 0.00 | +12.32 | 13 | +0.04 | +3.47 |
| 04 | 6 | +0.54 | +7.58 | 13 | +0.01 | +3.21 |
| 05 | 8 | +0.14 | +11.76 | 14 | +0.09 | +3.01 |
| 06 | 9 | +0.02 | +13.51 | 15 | +0.08 | +5.08 |

In Table 3, the results of UMHS+DAcc, UMHS+Comp, EPZS+DAcc, and EPZS+Comp are shown for clips that contain horizontal movement. The SaVE-enhanced UMHS and EPZS may achieve speedups by up to 24.60 percent and 17.96 percent, respectively. The results may also indicate that using the digital compass may be more stable and efficient than using the dual accelerometers in reducing the overall motion estimation time.

TABLE 3
CSWS, PSNR Gains, and Speedup achieved by SaVE-enhanced
UMHS and EPZS for clips with horizontal movement
SaVE-enhanced UMHS

| | | | | UMHS + Comp (SWS = 3) | | |
|---|---|---|---|---|---|---|
| | UMHS + DAcc (SWS = 3) | | | | PSNR | |
| | | PSNR | Speedup | | Gains | Speedup |
| Clip | CSWS | Gains (dB) | (%) | CSWS | (dB) | (%) |
| 07 | 4 | +0.16 | +13.88 | 6 | +0.24 | +16.41 |
| 08 | 5 | +0.24 | +17.31 | 6 | +0.29 | +15.16 |
| 09 | 6 | +0.22 | +17.84 | 10 | +0.26 | +24.25 |
| 10 | 5 | +0.24 | +16.71 | 9 | 0.00 | +23.58 |
| 11 | 5 | +0.06 | +16.21 | 7 | +0.01 | +17.99 |
| 12 | 4 | +0.02 | +13.79 | 8 | +0.02 | +24.60 |
| | | | | UMHS + Comp (SWS = 11) | | |
| | UMHS + DAcc (SWS = 11) | | | | PSNR | |
| | | PSNR | Speedup | | Gains | Speedup |
| Clip | CSWS | Gains (dB) | (%) | CSWS | (dB) | (%) |
| 07 | 16 | +0.19 | +5.92 | 18 | +0.03 | +12.93 |
| 08 | 19 | +0.06 | +8.47 | 17 | +0.06 | +11.45 |
| 09 | 18 | 0.00 | +7.99 | 17 | +0.04 | +11.61 |
| 10 | 17 | +0.03 | +7.53 | 16 | +0.05 | +10.82 |
| 11 | 20 | +0.05 | +11.20 | 17 | +0.02 | +13.20 |
| 12 | 17 | +0.03 | +6.07 | 14 | +0.15 | +7.98 |

SaVE-enhanced EPZS

| | | | | EPZS + Comp (SWS = 3) | | |
|---|---|---|---|---|---|---|
| | EPZS + DAcc (SWS = 3) | | | | PSNR | |
| | | PSNR | Speedup | | Gains | Speedup |
| Clip | CSWS | Gains (dB) | (%) | CSWS | (dB) | (%) |
| 07 | 5 | +0.09 | +7.01 | 6 | +0.25 | +11.61 |
| 08 | 5 | +0.42 | +9.94 | 6 | +0.28 | +10.79 |
| 09 | 6 | +0.06 | +12.51 | 10 | +0.12 | +13.91 |
| 10 | 5 | +0.34 | +8.70 | 9 | +0.06 | +13.68 |
| 11 | 5 | +0.13 | +6.09 | 6 | +0.29 | +10.94 |
| 12 | 4 | +0.07 | +5.10 | 8 | +0.02 | +13.64 |
| | | | | EPZS + Comp (SWS = 11) | | |
| | EPZS + DAcc (SWS = 11) | | | | PSNR | |
| | | PSNR | Speedup | | Gains | Speedup |
| Clip | CSWS | Gains (dB) | (%) | CSWS | (dB) | (%) |
| 07 | 18 | +0.07 | +3.95 | 19 | +0.03 | +9.34 |
| 08 | 20 | +0.04 | +7.03 | 18 | +0.07 | +7.65 |
| 09 | 18 | +0.04 | +6.03 | 17 | +0.05 | +6.75 |
| 10 | 18 | +0.03 | +5.28 | 17 | +0.02 | +6.70 |
| 11 | 20 | +0.15 | +17.96 | 17 | +0.06 | +7.93 |
| 12 | 19 | 0.00 | +5.29 | 15 | +0.08 | +6.52 |

As shown in Table 2 and Table 3, the SaVE may achieve substantial speedups for the tested video clips, which are designed to represent a wide variety of combinations of global and local motions. The SaVE may take advantage of traditional GME for predictive motion estimation, but may also estimate the global motion differently. With relatively small overhead, the SaVE may be capable of substantially reducing the computations required for H.264?AVC motion estimation.

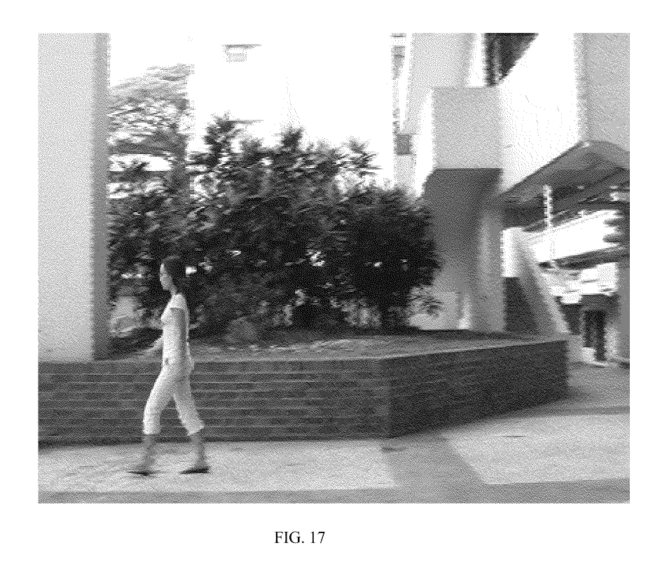

FIG. 15 shows a PSNR plot for a video clip containing complicated and extensive local motion. The video clip was captured in a busy crossroad with various local motion introduced by fast moving vehicles and slow moving pedestrians, at various distances to the camera. As shown in FIG. 15, the SaVE/Comp may still outperform the original algorithms but with reduced improvement, e.g. compared to Clip03 to Clip12 in FIG. 12 and FIG. 13. The improvement may be further reduced for SaVE/DAcc since it may partially rely on the motion vectors in the previous frame. The reduction in improvement may be expected since SaVE may provide extra information about global motion and not local motion.

### Example 3

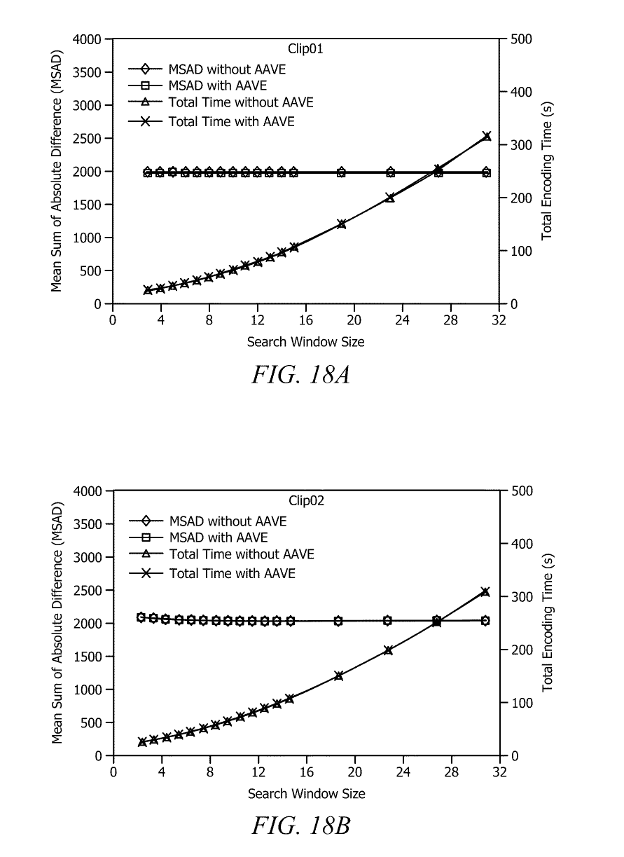

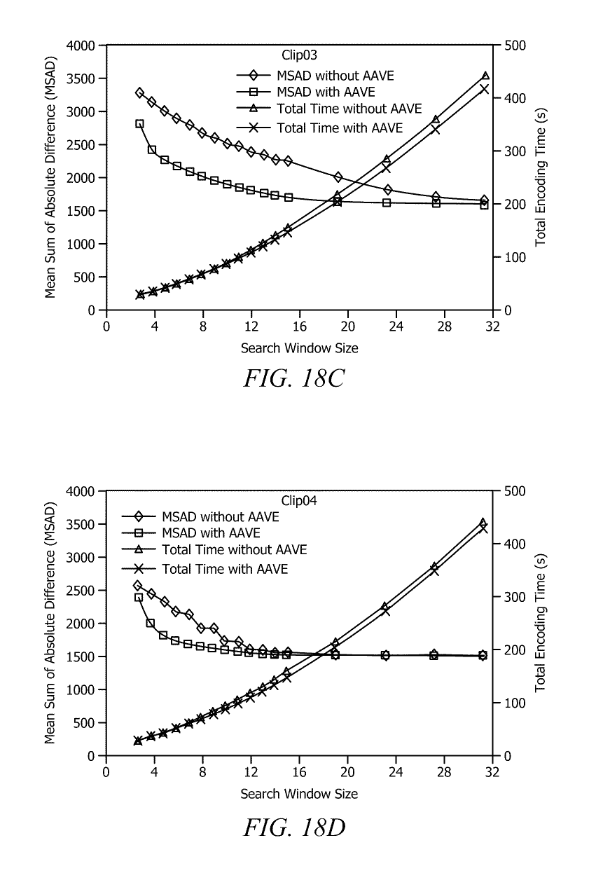

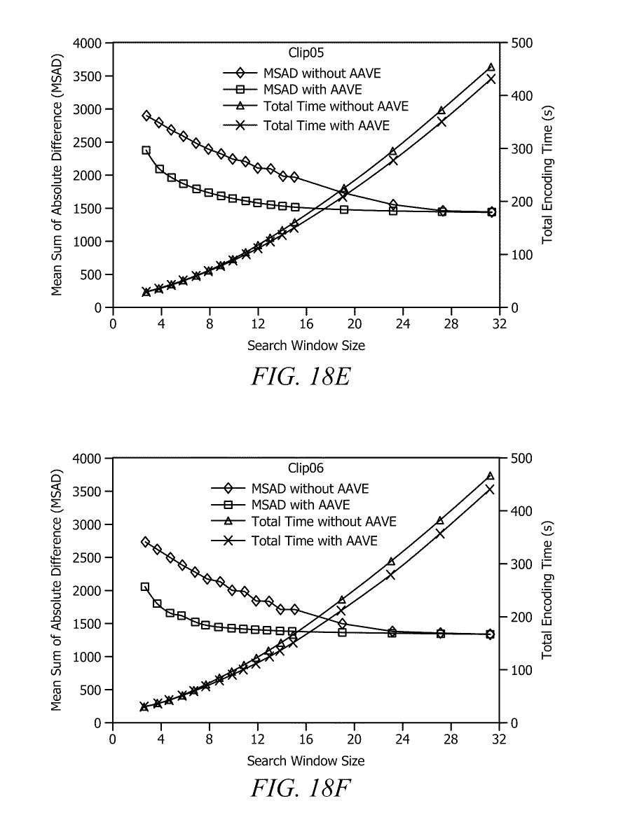

FIGS. 16a, 16b, and 16c illustrate an AAVE prototype coupled to a camera, which may comprise a video encoder similar to the video encoder 200. FIG. 16a shows a sensor board component of the AAVE prototype. The sensor board is an in-house Bluetooth sensor board that comprises two tri-axis accelerometers. The sensor board was based on interconnecting an in-house designed sensor adapter with a three-axis accelerometer from Kionix (KXM52-1050) and a development board from Kionix for the second accelerometer. The sensor adapter employs a Texas Instruments MSP430 microcontroller to read three-axis acceleration from the two accelerometers. The reading is based on MSP430's 12-bit ADC interfaces and its sampling rate is equal to about 64 Hertz (Hz). The sensor board sends the collected data through Bluetooth to a data collecting PC in real time, as shown in FIG. 16c. FIG. 16b shows a handheld camcorder firmly bundled to the sensor board, similar to the SaVE prototype, which has a resolution of about 576×480 pixels and a frame rate of about 25 fps. The camcorder does not support raw video sequence format, and therefore the captured sequences are converted in post-processing stage to the host PC. The sampling rate of the sensor board is higher than the frame rate of the video sequences and the acceleration data obtained using the sensor board may have noise. Therefore, a low-pass filter and linear interpolation are used to calculate the corresponding sample for each video frame. Additionally, the detected sensor (acceleration) data and the captured video may be synchronized manually similar to the SaVE prototype.

The AAVE scheme was implemented during encoding the synchronized raw video sequence and its acceleration data. Specifically, the MPEG-2 reference encoder in the motion estimation routine is modified to utilize the acceleration data during video encoding. For each predictive frame (P- and B-frame), global horizontal and vertical motion vectors were calculated from acceleration readings. Each sequence is then encoded with a GOP of about ten frames. The first frame of each GOP is encoded as an I-frame and the remaining nine frames are encoded as P-frames. Each sequence was cut to about 250 frames (about ten seconds to about 25 fps) and the corresponding acceleration data contains about 640 samples (64 samples per second). All sequences were encoded with a fixed bitrate at about two Mbps. For each sequence, the original encoder is expected to produce bitstreams with the same bitrate and different video quality versus the motion estimation search range. A larger search range may produce smaller residual error in motion estimation and thus better overall video quality.

The overhead of the AAVE prototype may include the accelerometer hardware and acceleration data processing. The accelerometer hardware may have low power (less than about one mW) and low cost (around ten dollars). The accelerometer power consumption may be negligible in comparison to the much higher power consumption by the processor for encoding (about several hundreds milli-Watts or higher). Moreover, more portable devices have built-in accelerometers though for different purposes. The acceleration data by AAVE may be obtained efficiently, and require an overhead less than about one percent of that which the entire motion estimation module requires. The fact the acceleration data requires relatively small power consumption is because the AAVE estimates motion vectors for global motion and not local motion, once for each frame. In view of the substantial reduction in the computation load achieved by the AAVE (greater than about 50 percent), the computation load for obtaining acceleration data is negligible.

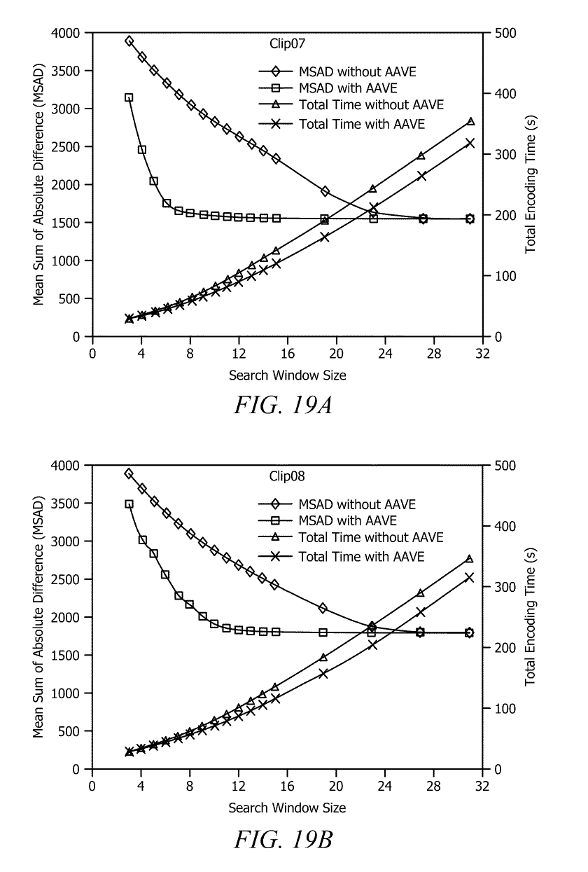

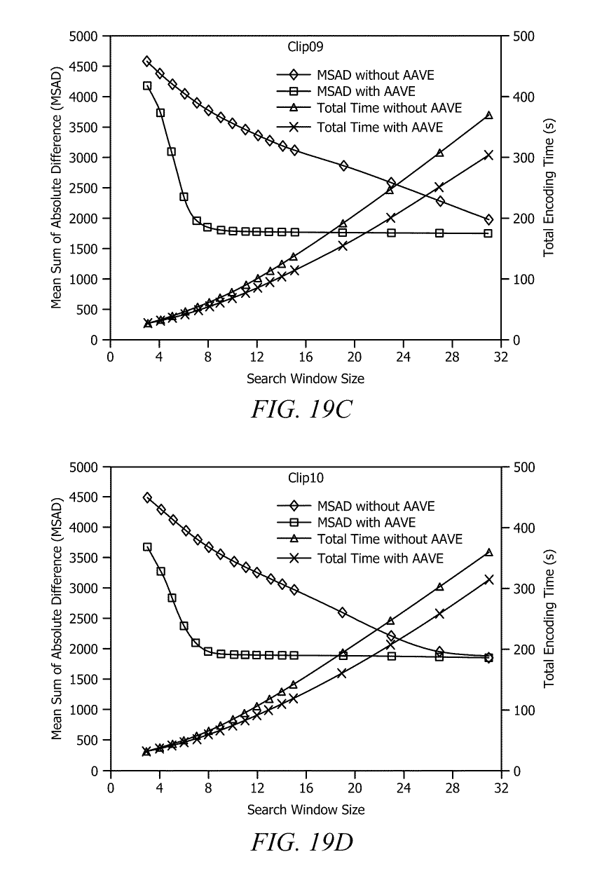

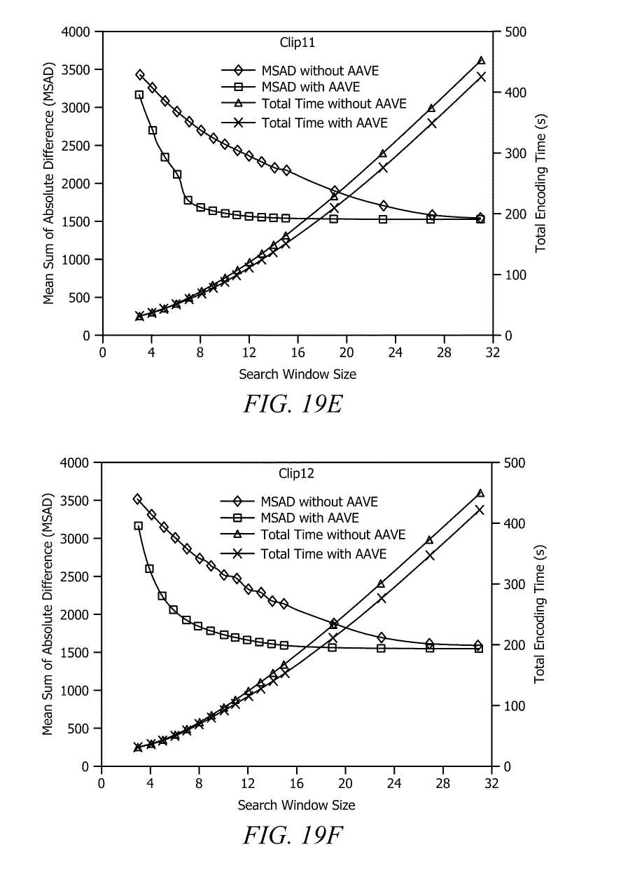

The camcorder was used to capture about 12 video clips with different combinations of global (camera) and local (object) motions, as shown in Table 1. FIG. 17 shows a typical scene and object for captured clips. FIG. 18 and FIG. 19 show the Mean Sum of Absolute Difference (MSAD) after motion estimation for the video clips. The MSAD may be used instead of the PSNR to evaluate the effectiveness of the AAVE scheme. The MSAD is obtained by calculating the SAD between the original macro-block and the predicted macro-block by motion estimation, and then by averaging the SAD by all the macro-blocks in P- and B-frames. The PSNR was also calculated as a reference. Additionally, FIG. 18 and FIG. 19 show the computation load of video encoding with and without AAVE in terms of the runtime or total encoding time, which was calculated using a Windows-based PC with 2.33 GHZ Intel Core 2 Duo processor and about 4 GB memory. The results are shown for each clip with and without AAVE encoding for a range of search window size (from 3 to 32). FIG. 8 and FIG. 9 may present the tradeoffs between the search window size and the achieved MSAD and encoding time for all 12 clips. As shown, a larger search window may lead to increased encoding time and typically to reduced MSAD. Further, the application of AAVE may lead to substantially lower MSAD for the same search window size and therefore to substantially less encoding time for the same MSAD.

Clip01 and Clip02 were captured with the camera held still. As such, the AAVE may not improve the MSAD since the acceleration in this case is equal to about zero. The average MSAD may not vary much as the search window size is enlarged from 3×3 to 31×31 pixels. A small search window may be adequate for local motion due to object movement. When the acceleration reading is insignificant, meaning that the camera is still, the AAVE may keep the search window size to about 5×5 pixels, which may speedup the encoding by over twice compared to the default search window size 11×11. Clip03, Clip04, Clip05, and Clip06 were captured with the camera moving vertically. A much smaller window size may be used with the AAVE in motion estimation to achieve the same MSAD. For example, a search window of 4×4 with AAVE achieves about the same MSAD with that of 11×11 without AAVE for Clip06, and the entire encoding process may speed up by over three times.

Clip07, Clip08, Clip09, and Clip10 were captured with the camera moving horizontally. As such, the AAVE may achieve the same MSAD with a much smaller window size and about two to three times of speedup for the whole encoding process. As for Clip11 and Clip12 that were captured with irregular and random movements, the AAVE may save considerable computation. For both clips, the AAVE scheme may achieve the same MSAD with a search window of 5×5 in comparison to that of 11×11 without AAVE, which may be over 2.5 times of speedup for the entire encoding process. Table 4 summarizes the speedup of the entire encoding process by AAVE for all the clips. Table 4 shows the PSNR and total encoding time that may be achieved using AAVE with the same MSAD of the conventional encoder using a full search window of 11×11 pixels. The AAVE produces the same or even slightly better PSNR and is about two to three times faster, while achieving the same MSAD. The AAVE speeds up encoding by over two times even for clips with a moving object by capturing global motion effectively.

TABLE 4
Computational saving for the clips in Table 2

| | | | AAVE with | | |
|---|---|---|---|---|---|
| | Conventional | | Equivalent | | |
| | Encoding | | MSAD | | |
| | | Total | | Total | |
| | | Encoding | | Encoding | |
| Clip | PSNR | Time (s) | PSNR | Time (s) | Speedup (X) |
| 01 | 27.7 | 73.1 | 27.6 | 30.9 | 2.37 |
| 02 | 27.6 | 73.0 | 27.5 | 35.4 | 2.06 |
| 03 | 27.7 | 100.0 | 28.4 | 33.8 | 2.96 |
| 04 | 29.6 | 104.5 | 29.9 | 48.8 | 2.14 |
| 05 | 28.6 | 101.8 | 29.4 | 34.1 | 2.99 |
| 06 | 29.2 | 106.4 | 30.2 | 34.5 | 3.08 |
| 07 | 27.2 | 93.3 | 28.8 | 33.0 | 2.82 |
| 08 | 26.5 | 90.8 | 27.7 | 43.3 | 2.10 |
| 09 | 26.1 | 89.5 | 27.2 | 37.5 | 2.39 |
| 10 | 25.8 | 92.2 | 27.0 | 32.5 | 2.84 |
| 11 | 28.0 | 103.3 | 28.9 | 41.4 | 2.50 |
| 12 | 27.6 | 107.8 | 28.8 | 42.7 | 2.53 |

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, Rₗ, and an upper limit, Rᵤ, is disclosed, any number falling within the range is specifically disclosed. In particular, the following numbers within the range are specifically disclosed: R=Rₗ+k*(Rᵤ−Rₗ), wherein k is a variable ranging from 1 percent to 100 percent with a 1 percent increment, i.e., k is 1 percent, 2 percent, 3 percent, 4 percent, 5 percent, . . . , 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present disclosure. The discussion of a reference in the disclosure is not an admission that it is prior art, especially any reference that has a publication date after the priority date of this application. The disclosure of all patents, patent applications, and publications cited in the disclosure are hereby incorporated by reference, to the extent that they provide exemplary, procedural, or other details supplementary to the disclosure.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

What is claimed is:

1. An apparatus comprising:
a sensor assisted video encoder (SaVE) configured to estimate global motion in a video sequence using sensor data;
at least one sensor coupled to the SaVE and configured to generate the sensor data; and
a camera equipped device coupled to the SaVE and the sensor and configured to capture the video sequence,
wherein the SaVE estimates local motion in the video sequence based on the estimated global motion to reduce encoding time.

2. The apparatus of claim 1, wherein the SaVE is an accelerometer assisted video encoder (AAVE) and wherein the sensor comprises two tri-axis accelerometers aligned with the camera equipped device.

3. The apparatus of claim 1, wherein the sensor comprises a tri-axis digital compass and a tri-axis accelerometer aligned with the camera equipped device.

4. The apparatus of claim 1, wherein the sensor comprises a gyroscope.

5. The apparatus of claim 1, wherein the camera equipped device is a camcorder.

6. The apparatus of claim 1, wherein the camera equipped device is a camera equipped mobile phone.

7. An apparatus comprising:
a camera configured to capture a plurality of images of an object;
a sensor configured to detect a plurality of vertical movements and horizontal movements corresponding to the images; and
at least one processor configured to implement a method comprising:
obtaining the images and the corresponding vertical movements and horizontal movements;
calculating a plurality of motion vectors using the vertical movements and the horizontal movements;
using the calculated motions vectors to find a plurality of initial search positions for motion estimation in the images; and
encoding the images by compensating for motion estimation.

8. The apparatus of claim 7, wherein the vertical movements comprise vertical rotations of the camera with respect to the object, and wherein the horizontal movements comprise horizontal rotations of the camera with respect to the object.

9. The apparatus of claim 8, wherein the sensor comprises an accelerometer and the vertical rotations are obtained using the accelerometer according to Δθᵥ=Pₙ−Pₙ₋₁, wherein Δθᵥ is a vertical rotational change between two subsequently captured frames, Pₙ is the vertical angle of the camera at the frame n, and Pₙ₋₁ is the vertical angle of the camera at the frame n−1.

10. The apparatus of claim 8, wherein the sensor comprises a digital compass and the horizontal rotations are obtained using the digital compass according to Δθₕ=Hₙ−Hₙ₋₁, wherein Δθₕ is a horizontal rotational change between two subsequently captured frames, Hₙ is the horizontal angle of the camera at the frame n, and Hₙ₋₁ is the horizontal angle of the camera at the frame n−1.

11. The apparatus of claim 8, wherein the sensor comprises two accelerometers and the horizontal rotations are obtained using the two accelerometers according to Δθₕ(n)=Δθₕ(n−1)+k·(S_{0y}−S_{1y}), wherein Δθₕ(n) is a horizontal rotational change during the frame n, Δθₕ(n−1) is a horizontal rotational change during the frame n−1, S_{0y} and S_{1y} are the acceleration measurements in the y direction perpendicular to the distance between the two accelerometers, and k is a constant calculated from the distance between the two accelerometers, the frame rate, and the pixel-per-degree resolution of the camera.

12. The apparatus of claim 8, wherein the motion vectors comprise vertical motion vectors Δdᵥ and horizontal motion vectors Δdₕ, wherein the vertical motion vectors are calculated according to Δdᵥ≈f·Δθᵥ, and wherein the horizontal motion vectors are estimated according to Δdₕ≈f·Δθₕ, where f is the focal length of the camera lens.

13. The apparatus of claim 8, wherein using the motion vectors reduces the search window size of the search algorithm for motion estimation and reduces overall encoding time.

14. The apparatus of claim 13, wherein the search algorithm is a full search algorithm.

15. The apparatus of claim 13, wherein the search algorithm is a Multi-Hexagon-grid Search (UMHS) algorithm.

16. The apparatus of claim 13, wherein the search algorithm is an Enhanced Predictive Zonal Search (EPZS).

17. A method comprising:
obtaining a video sequence;
obtaining sensor data synchronized with the video sequence;
converting the sensor data into global motion predictors;
using the global motion predictors to reduce the search range for local motion estimation; and
using a search algorithm for local motion estimation based on the reduced search range.

18. The method of claim 17, wherein converting the sensor data into global motion predictors requires about one percent of total power for video encoding.

19. The method of claim 17, wherein using the global motion predictors to reduce the search range for local motion estimation reduces overall encoding time by at least about two times.

20. The method of claim 17, wherein reducing the search range for local motion estimation does not reduce the Peak Signal-to-Noise Ratio (PSNR).
